(19) United States
(12) Patent Application Publication
(10) Pub. No.: US 2012/0052799 A1
(43) Pub. Date: Mar. 1, 2012

(54) Wireless digital audio reproduction system capable remote control

(76) Inventor: Ming-Fure Jeng, New Taipei City (TW)

(21) Appl. No.: 13/136,569

(22) Filed: Aug. 4, 2011

(30) Foreign Application Priority Data
Aug. 25, 2010 (TW) 099128417

(51) Int. Cl. H04W 4/00

(52) U.S. Cl. 455/39

(57) ABSTRACT

A wireless digital audio reproduction system includes: a first device having a first control module configured to control a first wireless communication module, in response to triggering when the first device is in a standby state, for generating an operational signal associated with identification information that corresponds to the first device, and for transmitting the operational signal thus generated via at least one of a plurality of communication channels; and a second device having a second control module configured to control a second wireless communication module for receiving the operational signal via a designated one of the communication channels that is designated by one of the first and second control modules, and to determine whether to control the second device to enter an operational state according to the operational signal received thereby.

### CROSS-REFERENCE TO RELATED APPLICATION

This application claims priority of Taiwanese Application No. 099128417, filed on Aug. 25, 2010.

### BACKGROUND OF THE INVENTION

1. Field of the Invention

The present invention relates to a wireless digital audio reproduction system, more particularly to a wireless digital audio reproduction system capable of remote control.

2. Description of the Related Art

As signal processing techniques advance, digital data may now be communicated in digital form via wireless channels with relatively narrow bandwidths. The digital data may include such as sound information, control signals, system configuration parameters, and battery information.

Taiwanese Patent No. 203410 discloses a wireless microphone capable of frequency modulation (FM) transmission and infrared remote control. The microphone is configured to generate an analog-sound signal corresponding to sound acquired thereby, to perform amplification upon the analog-sound signal so as to generate an amplified analog-sound signal, to perform frequency modulation upon the amplified analog-sound signal so as to generate a modulated signal, and to transmit the modulated signal to a receiver device via a frequency modulation channel for subsequent processing and audible reproduction thereby. From the aspect of remote control, when a switch of the microphone is triggered, an infrared modulation circuit of the microphone is configured to perform modulation upon a control signal for subsequent transmission to, and processing and execution by the receiver device.

The aforesaid microphone, which is an analog microphone, may be converted into a digital one by replacing field-effect transistors thereof by an analog-to-digital chip, which enables the microphone to generate digital signals. However, since transmission of digital signals generally require rather wide bandwidths, transmission of digital signals generated by the microphone may still be based upon conventional analog modulation techniques, which compromises quality of audible reproduction of the digital signals. In terms of remote control, infrared transmission is susceptible to obstructions, is characterized by lower transmission power, and hence is not suitable for long distance transmission in a complex environment.

### SUMMARY OF THE INVENTION

Therefore, an object of the present invention is to provide a wireless digital audio reproduction system capable of alleviating the aforesaid drawbacks of the prior art.

Accordingly, a wireless digital audio reproduction system of the present invention includes first and second devices.

The first device includes a first wireless communication module, and a first control module coupled to the first wireless communication module, and configured to control the first wireless communication module, in response to triggering when the first device is in a standby state, for generating an operational signal associated with identification information that corresponds to the first device, and for transmitting the operational signal thus generated via at least one of a plurality of communication channels.

The second device includes a second wireless communication module, and a second control module coupled to the second wireless communication module, and configured to control the second wireless communication module for receiving the operational signal via a designated one of the communication channels, and to determine whether to control the second device to enter an operational state according to the operational signal received thereby, the designated one of the communication channels being designated by one of the first and second control modules.

When the second wireless communication module receives the operational signal, the second control module is configured to control the second wireless communication module for generating a channel-designate signal associated with the identification information that corresponds to the first device, and for transmitting the channel-designate signal thus generated to the first device, whereby the first device transmits information to the second device through the designated one of the communication channels when the first device receives the channel-designated signal.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram to illustrate first and second devices of the first preferred embodiment of a wireless digital audio reproduction system according to the present invention;

FIG. 2 is a timing diagram to illustrate phases of operation of the first and second devices;

FIG. 3 is a flowchart to illustrate steps performed by the wireless digital audio reproduction system to enter an operational state;

FIG. 4 is a timing diagram to illustrate the steps performed by the wireless digital audio reproduction system to enter the operational state;

FIG. 5 is a flowchart to illustrate steps performed by the wireless digital audio reproduction system to enter a standby state;

FIG. 6 is a timing diagram to illustrate the steps performed by the wireless digital audio reproduction system to enter the standby state;

FIG. 7 is a block diagram to illustrate first and second devices of the second preferred embodiment of a wireless digital audio reproduction system according to the present invention;

FIG. 8 is a flowchart to illustrate steps performed by the first device of the second preferred embodiment upon triggering to enable the second device of the second preferred embodiment to enter an operational state; and

FIG. 9 is a flowchart to illustrate steps performed by the second device of the second preferred embodiment to enter the operational state.

### DETAILED DESCRIPTION OF THE PREFERRED EMBODIMENTS

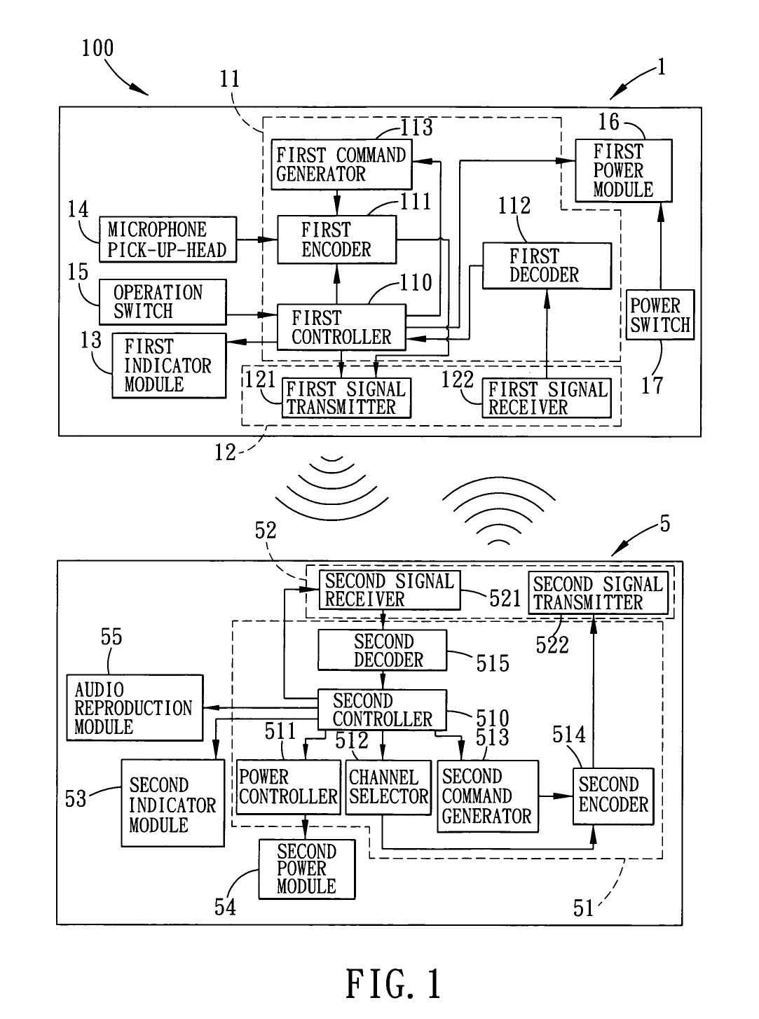

Referring to FIG. 1, the first preferred embodiment of a wireless digital audio reproduction system 100 of the present invention includes first and second devices 1, 5. The first device 1 is operable to transmit audio signals and non-audio signals (e.g., first control signals) to the second device 5 via at least one wireless communication channel. The second device 5 is operable to transmit non-audio signals (e.g., second control signals) to the first device 1 via the at least one wireless communication channel.

The wireless communication channels may occupy frequencies in the industrial, scientific and medical (ISM) frequency bands or any other frequency bands. It is to be noted that, in other embodiments, the first and second devices 1, 5 may be configured to send information to each other via different communication channels. For example, the first device 1 may be configured to transmit information to the second device 5 via a non-ISM communication channel, and the second device 5 may be configured to transmit information to the first device 1 via an ISM communication channel.

When transmitting data to the first device 1 via a relatively wide frequency band, the second device 5 is configured to perform one of a direct sequence spread spectrum (DSSS) technique, a frequency hopping spread spectrum technique, and a combination thereof, such that the data thus transmitted is less susceptible to interference and noise. Like most wireless telecommunication systems, at least one communication channel must be established between the first and second devices 1, 5 before communication of user data therebetween may take place.

In this embodiment, the first device 1 is a wireless microphone including a first control module 11, a first wireless communication module 12, a first indicator module 13, a microphone pick-up-head 14, an operation switch 15, a first power module 16, and a power switch 17. The first control module 11 includes a first controller 110, a first encoder 111, a first decoder 112, and a first command generator 113. The first wireless communication module 12 includes a first signal transmitter 121 and a first signal receiver 122.

The operation switch 15 is user-operable for controlling operations of the first and second devices 1, 5. The power switch 17 is user-operable to control operation of the first power module 16 for providing power to various components of the first device 1. In this embodiment, the first device 1 is in a power-off state when each of the operation and power switches 15, 17 is in an “OFF” status, in an operational state when each of the operation and power switches 15, 17 is in an “ON” status, and in a standby state when the operation switch 15 is in the “OFF” status and the power switch 17 is in the “ON” status. The first power module 16 is powered off when the first device 1 is in the power-off state, and is operable to supply power to the various components when the first device 1 is in one of the standby and operational states.

The first controller 110 is operable for coordinating operations of the various components of the first device 1, and is configured to control the first command generator 113 to generate a first control command (e.g., an operational command associated with such as identification information corresponding to the first device 1, or a standby command associated with the same) in response to triggering of the operation switch 15. Specifically, the first controller 110 is configured to control the first command generator 113 to generate an operational command upon triggering of the operation switch 15 when the first device 1 is in the standby state, (i.e., the second device 5 is to be switched from the standby state to the operational state), and to generate a standby signal upon triggering of the operation switch 15 when the first device 1 is in the operational state (i.e., the second device 5 is to be switched from the operational state to the standby state).

Next, the first encoder 111 is coupled to the first command generator 113 for receiving the first control command therefrom, and is configured to perform a first encoding process upon the first control command so as to generate a first encoded signal. In this embodiment, the first encoded signal contains parity information for error correction.

The first signal transmitter 121 is coupled to the first encoder 111 for receiving the first encoded signal therefrom, and is operable for performing a first modulation process upon the first encoded signal so as to generate a first modulated signal, and to transmit the first modulated signal to the second device 5 via at least one of the communication channels.

In this embodiment, the second device 5 is a wireless audio receiver device including a second control module 51, a second wireless communication module 52, a second power module 54, and an audio reproduction module 55. The second control module 51 includes a second controller 510, a power controller 511, a channel selector 512, a second command generator 513, a second encoder 514, and a second decoder 515. The second wireless communication module 52 includes a second signal receiver 521 and a second signal transmitter 522.

The second power controller 511 is configured to control operation of the second power module 54 to provide power to various components of the second device 5. When the second device 5 is in the standby state, the second power controller 511 remains in an operational state even if the second power module 54 is powered off, such that the second power controller 511 is able to power on the second power module 54 when the second device 5 is in the standby state. The channel selector 512 is operable to obtain a measure of quality, which takes into consideration interference and noise, for each of the communication channels through which the first and second devices 1, 5 may communicate, and is configured to designate one of the communication channels based on an interference-and-noise level thereof. In this embodiment, the designated one of the communication channels has a relatively low interference-and-noise level.

The second signal receiver 521 is for receiving the first modulated signal from the first signal transmitter 121, and is configured to perform a second demodulation process upon the first modulated signal thus received so as to generate a first demodulated signal. Next, the second decoder 515 is coupled to the second signal receiver 521 for receiving the first demodulated signal therefrom, and is configured to perform a second decoding process upon the first demodulated signal so as to generate a first decoded command. Furthermore, the second decoder 515 is configured to perform a second parity check process upon the first decoded command, to perform a second error-correction process upon the first decoded command if the second decoder 515 determines that the first decoded command contains error and parity information for error-correction, and to discard the first decoded command if the second decoder 515 determines that the first decoded command contains error but lacks parity information for error-correction.

The second controller 510 is operable for coordinating operations of the various components of the second device 5, and is configured to control the second command generator 513 to generate a second control command (e.g., a channel-available command associated with the identification information corresponding to the first device 1, or a channel-established signal associated with the same) according to the first decoded command.

The second encoder 514 is coupled to the second command generator 513 for receiving the second control command therefrom, and is configured to perform a second encoding process upon the second control command thus received so as to generate a second encoded signal. The second signal transmitter 522 is coupled to the second encoder 514 for receiving the second encoded signal therefrom, is configured to perform a second modulation process upon the second encoded signal so as to generate a second modulated signal, and transmits the second modulated signal to the first signal receiver 122 via the designated one of the communication channels. In this embodiment, the second modulated signal thus generated contains parity information for error correction.

The first signal receiver 122 is operable for receiving the second modulated signal from the second signal transmitter 522, and is configured to perform a first demodulation process upon the second modulated signal so as to generate a second demodulated signal. Next, the first decoder 112 is coupled to the first signal receiver 122 to receive the second demodulated signal therefrom, and is configured to perform a first decoding process upon the second demodulated signal so as to generate a second decoded command. Furthermore, the first decoder 112 is configured to perform a first parity check process upon the second decoded command, to perform a first error-correction process upon the second decoded command if the first decoder 112 determines that the second decoded command contains error and parity information for error-correction, and to discard the second decoded command if the first decoder 112 determines that the second decoded command contains error but lacks information for error-correction.

It is to be noted that the first and second communication modules 12, 52 may be implemented using one of multiple-input-multiple-output (MIMO), single-input-multiple-output (SIMO), and multiple-input-single-output (MISO) wireless channel communication frameworks. However, since a skilled artisan may readily appreciate implementation of such frameworks, details thereof will not be described hereinafter for the sake of brevity.

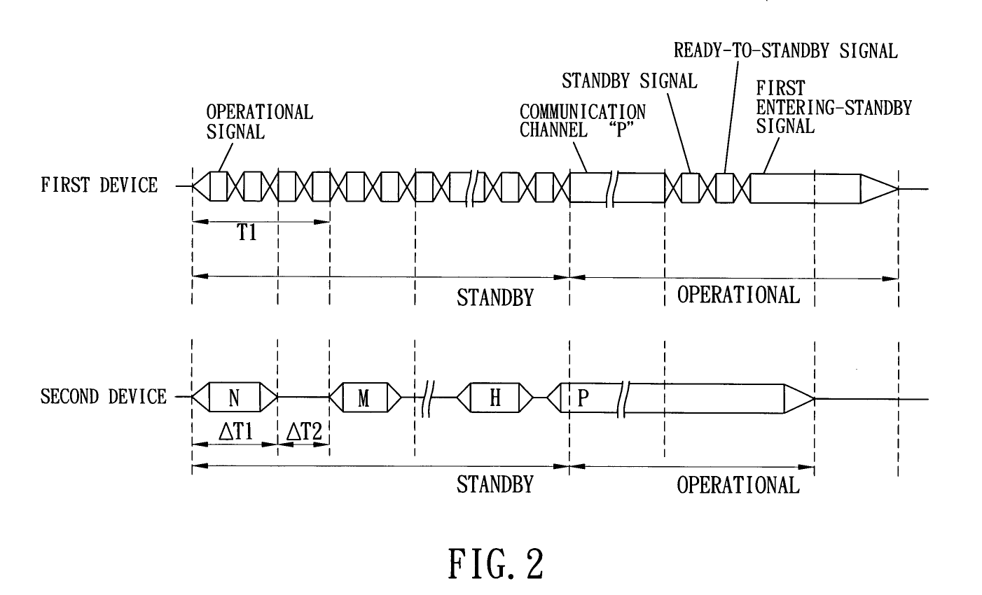

The mechanism through which the first and second devices 1, 5 communicate has heretofore been described. Next, referring to FIG. 2, phases of operation of the wireless digital audio reproduction system 100 will be described hereinafter.

### Entering the Operational State:

Upon triggering of the operation switch 15 when the first device 1 is in the standby state, the first device 1 is configured to generate and transmit an operational signal to the second device 5 via a predetermined number of the communication channels (in this embodiment, two of the communication channels) during a first predetermined interval “T1”. It is to be noted that signals generated by the first device 1 correspond to commands generated by the first command generator 113, and that signals generated by the second device 5 correspond to commands generated by the second command generator 513. For example, the operational signal generated by the first device 1 corresponds to an operational command generated by the first command generator 113.

When the second device 5 is in the standby state, the second device 5 is configured to power on a portion of the components thereof during a current one of the intermittent power-on time intervals “ΔT1” so as to attempt to receive the operational signal from the first device 1 via a current one of the communication channels

“N”. If the second device 5 fails to receive the operational signal via the current one of the communication channels “N” during the current one of the intermittent power-on time intervals “ΔT1”8 due to such as an interference-and-noise level of the current one of the intermittent power-on time interval “ΔT1” being higher than the predetermined threshold level, the second device 5 is configured to power off the portion of the components thereof during a current one of the intermittent power-off intervals “ΔT2”, and to power on the portion of the components again during a next one of the intermittent power-on intervals so as to attempt to receive the operational signal from the first device 1 via a next one of the communication channels “M”. In the standby state, the second device 5 is configured to repeat the aforesaid process until the operational signal is received thereby via one of the communication channels that has an interference-and-noise level lower than the predetermined threshold level.

It is worth noting that the portion of the components of the second device 5 powered on during each intermittent power-on interval includes the components that are responsible for receiving signals and for acquiring contents thereof. Such components include the second signal receiver 521, the second decoder 515, the second controller 510, the channel selector 512, the power controller 511, and the second power module 54.

Furthermore, since the operational signal is associated with the identification information corresponding to the first device 1, the second device 5 is able to identify the device from which the operational signal is transmitted. Such an identification mechanism is especially important in an application including a plurality of first devices 1.

A ratio between duration of the intermittent power-on interval and that of the intermittent power-off interval may be adjusted for adjusting an overall power consumption of the second device 5. If the duration of the intermittent power-off interval is substantially longer than that of the intermittent power-on interval, the second device 5 has a relatively low power consumption in the standby state. However, the chance of the second device 5 successfully receiving the operational signal will consequently be lower. On the contrary, if the duration of the intermittent power-off interval is substantially shorter than that of the intermittent power-on interval, the second device 5 has a relatively high power consumption in the standby state. However, the chance of the second device 5 successfully receiving the operational signal will consequently be higher.

In this embodiment, the second device 5 successfully receives the operational signal via communication channel “P”, and is configured to subsequently transmit information associated with communication channel “P” to the first device 1.

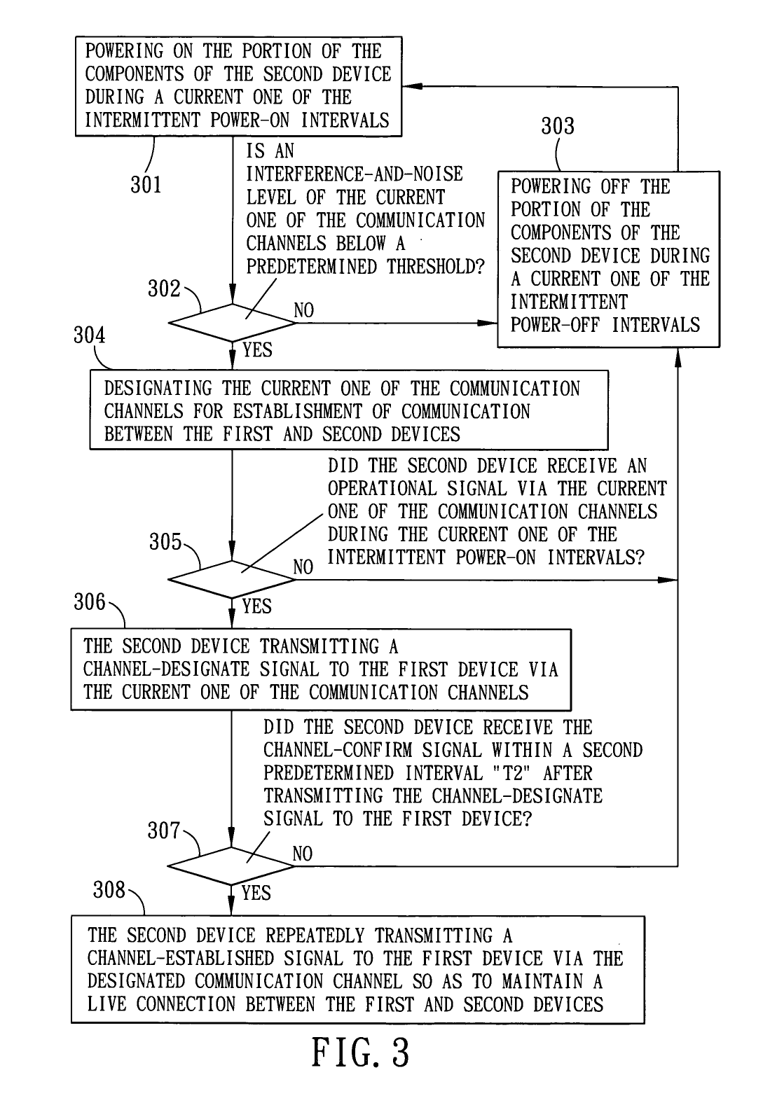

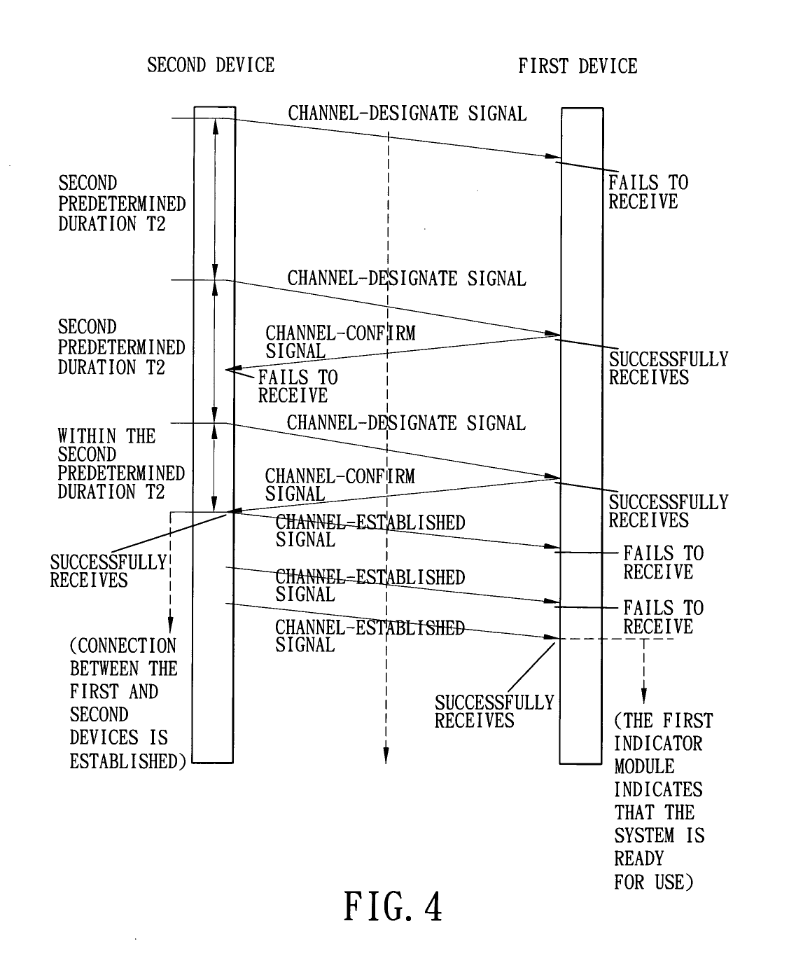

Shown in FIG. 3 is a flowchart to illustrate steps of the first preferred embodiment of a method performed by the first and second devices 1, 5 to enter the operational state, according to the present invention. Shown in FIG. 4 is a diagram to illustrate transmission of signals between the first and second devices 1, 5 while performing the steps.

In step 301, the second device 5 is configured to power on the portion of the components thereof during a current one of the intermittent power-on intervals.

In step 302, during the current one of the intermittent power-on intervals, the channel selector 512 of the second device 5 is configured to determine whether an interference-and-noise level of the current one of the communication channels is below a predetermined threshold, to proceed to step 304 if affirmative, and to proceed to step 303 if otherwise.

In step 303, the second device 5 is configured to power off the portion of the components thereof during a current one of the intermittent power-off intervals, and to proceed back to step 301 for subsequently determining the interference-and-noise level of a next one of the communication channels during a next of one of the intermittent power-on-intervals.

In step 304, the channel selector 512 is configured to designate the current one of the communication channels for establishment of communication between the first and second devices 1, 5, and to proceed to step 305. That is to say, the current one of the communication channels serves as the designated one of the communication channels.

In step 305, the second device 5 is configured to proceed to step 306 if the second device 5 receives the operational signal from the first device 1 via the current one of the communication channels during the current one of the intermittent power-on intervals, and to proceed to step 303 if otherwise.

In step 306, the second device 5 is configured to transmit a channel-designate signal, which corresponds to a channel-designate command generated by the second command generator 513 and associated with information corresponding to the current one of the communication channels (hereinafter referred to as the designated communication channel), to the first device 1, and to proceed to step 307. Upon receipt of the channel-designate signal, the first device 1 is configured to generate and transmit a channel-confirm signal, which corresponds to a channel-confirm command generated by the first command generator 113 and associated with the identification information that corresponds to the first device 1, to the second device 5 so as to confirm receipt of the channel-designate signal.

In step 307, the second device 5 is configured to proceed to step 308 if the second device 5 receives the channel-confirm signal within a second predetermined interval “T2” after the second device 5 transmitted the channel-designate signal to the first device 1, and to proceed to step 303 if otherwise.

In step 308, the second device 5 is configured to repeatedly transmit a channel-established signal, which corresponds to a channel-established command generated by the second command generator 513 and associated with the identification information that corresponds to the first device 1, to the first device 1 via the designated communication channel so as to maintain alive connection between the first and second devices 1, 5.

After performing step 308, the first device 1 may begin transmitting of audio signals acquired by the microphone pick-up-head 14 thereof via the designated communication channel to the second device 5 for audible reproduction by the audio reproduction module 55. The microphone pick-up-head 14 includes an analog-to-digital converter unit operable for performing an analog-to-digital conversion process upon the analog audio signal acquired by the microphone pick-up-head 14 so as to generate a digital audio signal, which is subjected to subsequent processing by the first encoder 111.

Referring to FIG. 4, when the first device 1 receives the channel-designate signal, the first controller 110 is configured to control the first command generator 113 to generate the channel-confirm command, and to provide the channel-confirm command thus generated to the first encoder 111 and the first signal transmitter 121 for generating the corresponding channel-confirm signal, which is subsequently transmitted to the second device 5. If the second signal receiver 521 fails to receive the channel-confirm signal during the current one of the intermittent power-on intervals, the channel selector 512 is configured to proceed to determining the interference-and-noise level of the next one of the communication channels during the next one of the intermittent power-on intervals.

Furthermore, when the first signal receiver 122 receives the channel-established signal, the first controller 110 is configured to control operation of the first indicator module 13 so as to indicate the wireless digital audio reproduction system 100 being in the operational state and being ready for use.

### Entering the Standby State:

Upon triggering of the operation switch 15 of the first device 1 when the second device 5 is in the operational state, the first device 1 is configured to generate and transmit a standby signal, which corresponds to a standby command generated by the first command generator 113 and associated with the identification information corresponding to the first device 1, to the second device 5 via the designated communication channel “P”.

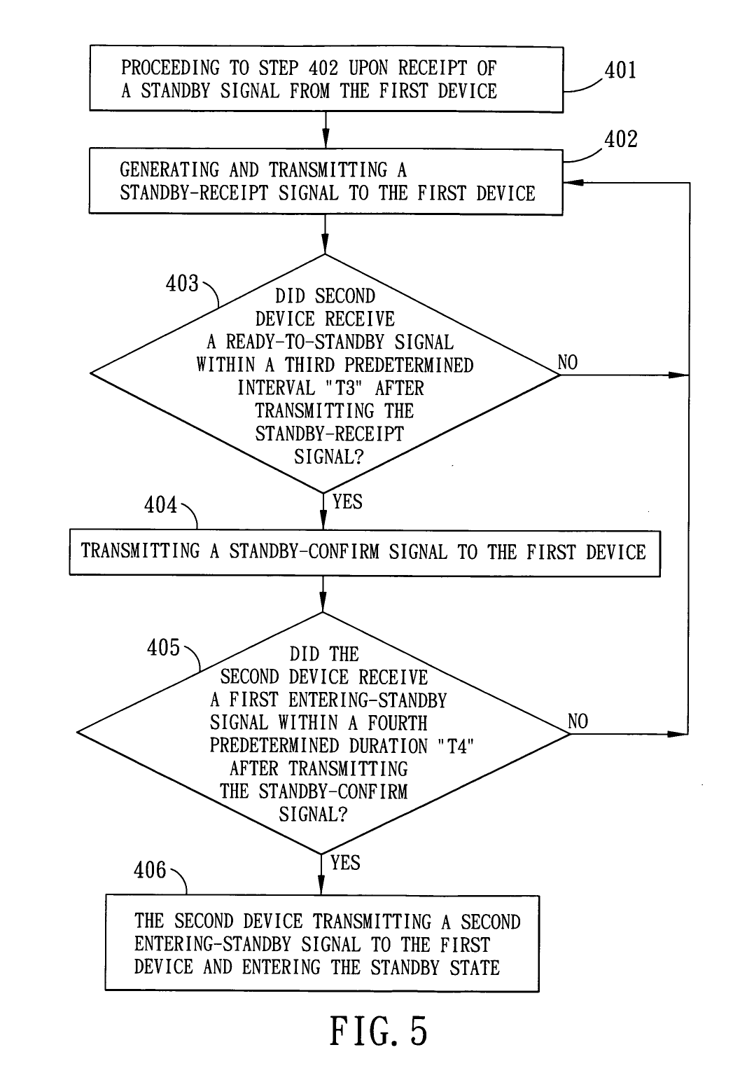

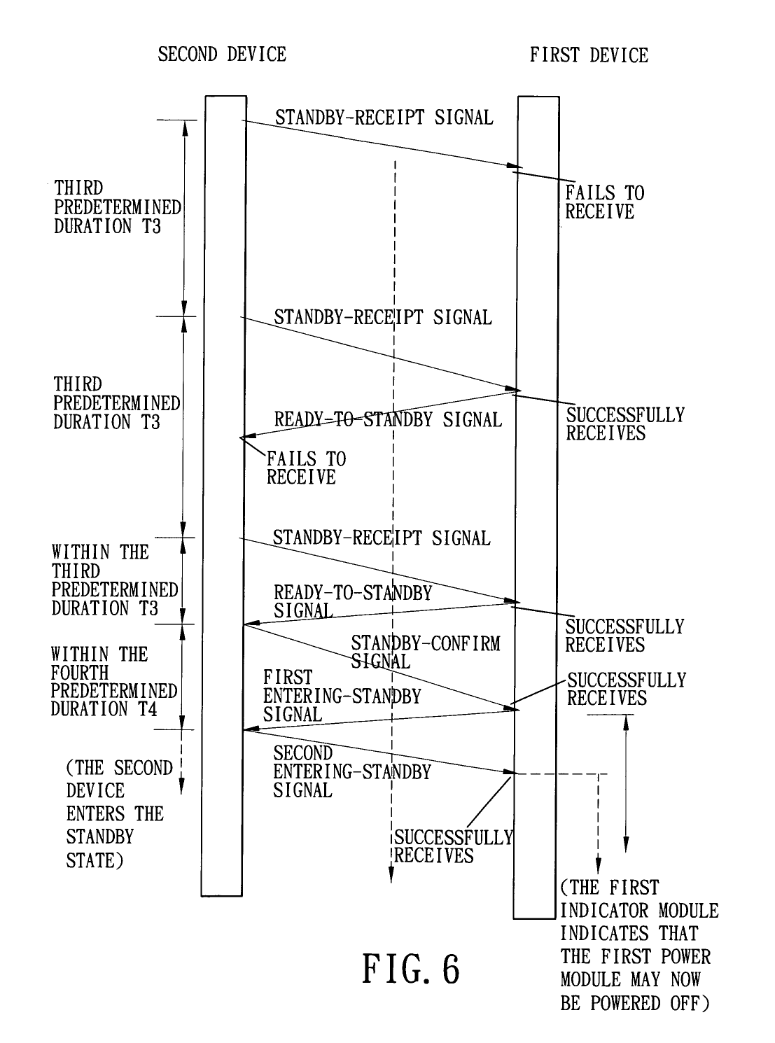

Referring to FIGS. 5 and 6, in step 401, the second device 5 is configured to proceed to step 402 upon receipt of the standby signal.

In step 402, the second device 5 is configured to generate and transmit a standby-receipt signal, which corresponds to a standby-receipt command generated by the second command generator 513 and associated with the identification information corresponding to the first device 1, to the first device 1, and to proceed to step 403. It is worth noting that the first device 1 is configured t repeatedly transmit the standby signal to the second device 5 until the first device 1 receives the standby-receipt signal. Upon receipt of the standby-receipt signal, the first device 1 is configured to generate and transmit a ready-to-standby signal, which corresponds to a ready-to-standby command generated by the first command generator 113 and is associated with the identification information corresponding to the first device 1, to the second device 5. The ready-to-standby signal indicates that the first device 1 is ready to enter the standby state.

In step 403, the second device 5 is configured to proceed to step 404 if the second device 5 receives the ready-to-standby signal within a third predetermined interval “T3” after the second device 5 transmitted the standby-receipt signal, and to proceed back to step 402 if otherwise.

In step 404, the second device 5 is configured to generate and transmit a standby-confirm signal, which corresponds to a standby-confirm command generated by the second command generator 513 and is associated with the identification information corresponding to the first device 1, to the first device 1 and to proceed to step 405. Upon receipt of the standby-confirm signal, the first device 1 is configured to generate and transmit a first entering-standby signal which corresponds to a first entering-standby command generated by the first command generator 113 and is associated with the identification information corresponding to the first device 1, to the second device 5 and to subsequently enter the standby state.

In step 405, the second device 5 is configured to proceed to step 406 if the second device 5 receives the first entering-standby signal within a fourth predetermined duration “T4” after transmitting the standby-confirm signal, and to proceed back to step 402 if otherwise.

In step 406, the second device 5 is configured to transmit a second entering-standby signal, which corresponds to a second entering-standby command generated by the second command generator 513 and is associated with the identification information corresponding to the first device 1, to the first device 1 and to subsequently enter the standby state.

Upon receipt of the second entering-standby signal, the first device 1 is configured to indicate via the first indicator module 13 that the second device 5 has entered the standby state and that the first device 1 may be powered off.

Under rare circumstances where the first entering-standby signal transmitted by the first device 1 is not received by the second device 5, a user may trigger the operational switch 15 to issue an operational signal to the second device 5, and to subsequently trigger the operational switch 15 again so as to transmit another standby signal to the second device 5 for enabling the second device 5 to enter the standby state.

It is to be noted that while performing steps 401 to 406, transmission of signals between the first and second devices 1, 5 is performed over the designated communication channel. However, in other embodiments, transmission of signals between the first and second devices 1, 5 may be performed over different communication channels.

Furthermore, the second and third predetermined durations “T2”, “T3” may be adjusted for optimizing quality of communication between the first and second devices 1, 5. For example, referring again to FIG. 6, the second device 5 may be configured to transmit the standby-receipt signal more than once within the third predetermined time “T3”, thereby increasing the probability of the first device 1 successfully receiving the standby-receipt signal.

It is noted that a registration procedure may be employed to register the first device 1 for use with the second device 5. Another procedure may be employed to remove the first device 1 from the registry of the second device 5.

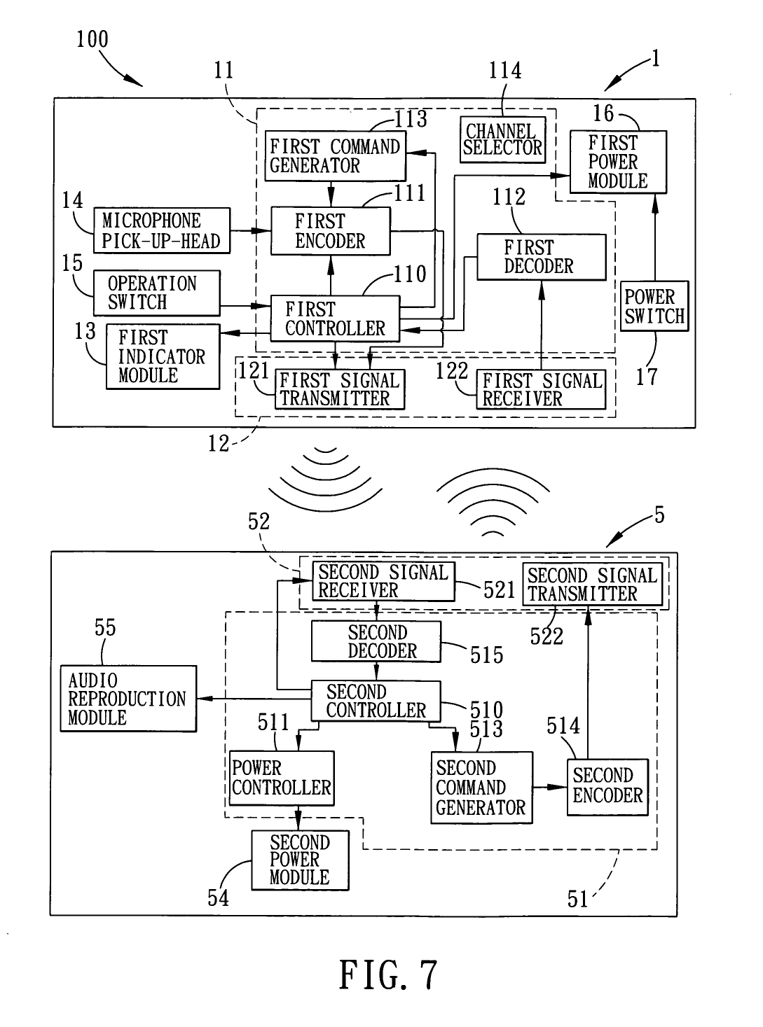

Referring to FIG. 7, the difference between the first and second preferred embodiments resides in that, in the second preferred embodiment, the first control module 11 of the first device 1 includes a channel selector 114, and the second control module 51 of the second device 5 does not include the channel selector 512, such that designation of the designated one of the communication channels is performed by the first device 1 instead of the second device 5.

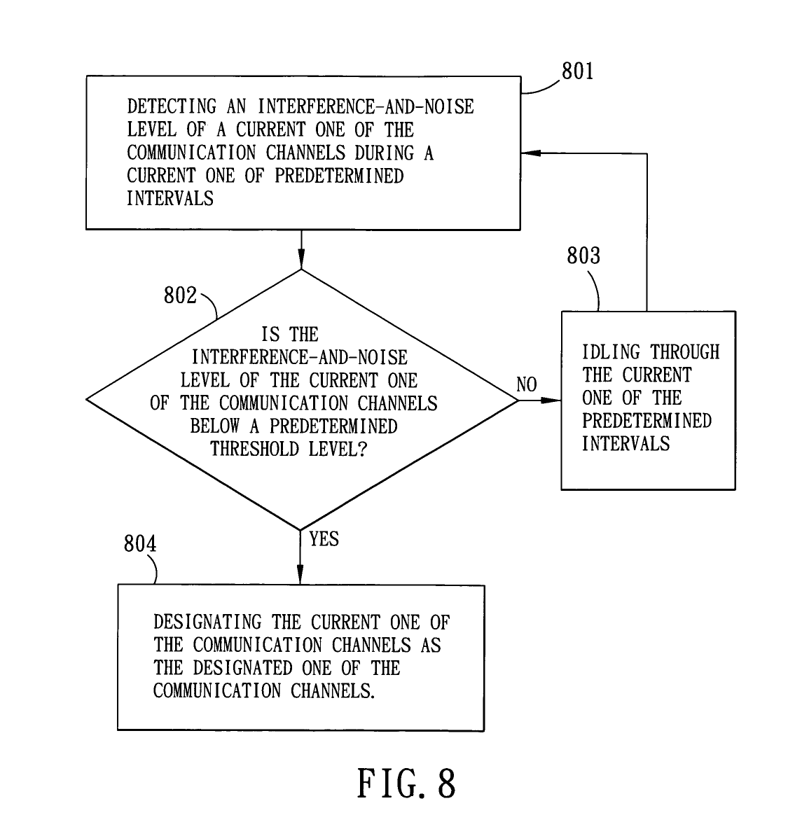

Referring to FIG. 8, the first device 1 is configured to perform steps 801 to 804 so as to designate one of the communication channels as the designated one of the communication channels.

In step 801, the channel selector 114 is configured to, upon triggering of the first control module 11 via the operation switch 15, detect an interference-and-noise level of a current one of the communication channels during a current one of predetermined intervals, and to proceed to step 802.

In step 802, the channel selector 114 is configured to proceed to step 804 if the channel selector 114 determines that the interference-and-noise level of the current one of the communication channels is below a predetermined threshold level, and to proceed to step 803 if otherwise.

In step 803, the channel selector 114 is configured to idle through the current one of the predetermined intervals, and to proceed back to step 801 for detecting the interference-and-noise level of a next one of the communication channels during a next one of predetermined intervals.

In step 804, the channel selector 114 is configured to designate the current one of the communication channels as the designated one of the communication channels.

Next, the first device 1 transmits the operational signal via the designated one of the communication channels.

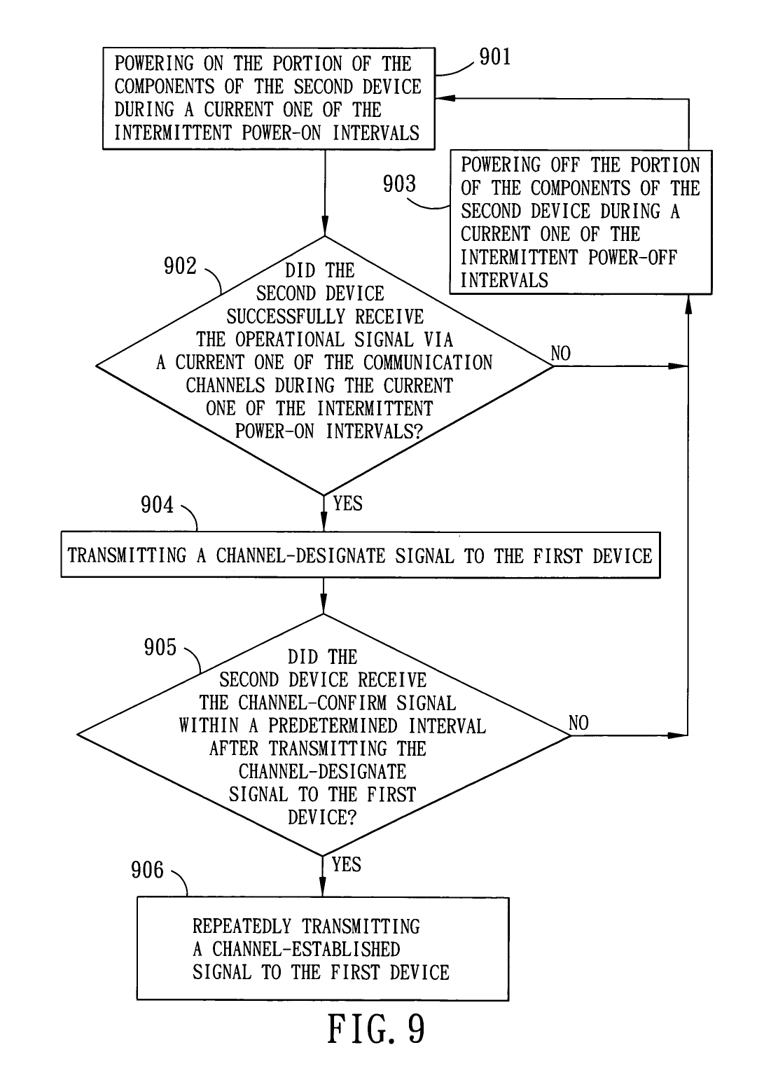

Referring to FIG. 9, in comparison with the first preferred embodiment, steps of a method performed by the second device 5 of the second preferred embodiment to enter the operational state are relatively simple.

In step 901, the second device 5 is configured to power on the portion of the components thereof during a current one of the intermittent power-on intervals, and to proceed to step 902.

In step 902, the second device 5 is configured to proceed to step 904 if the second device 5 successfully receives the operational signal via a current one of the communication channels during the current one of the intermittent power-on intervals, and to proceed to step 903 if otherwise.

In step 903, the second device 5 is configured to power off the portion of the components thereof during a current one of the intermittent power-off intervals, and to proceed back to step 901 for subsequently attempting to receive the operational signal via a next one of the communication channels during a next of one of the intermittent power-on-intervals.

In step 904, the second device 5 is configured to transmit a channel-designate signal, which corresponds to a channel-designate command generated by the second command generator 513 and associated with information corresponding to the designated one of the communication channels, to the first device 1, and to proceed to step 905. Upon receipt of the channel-designate signal, the first device 1 is configured to generate and transmit a channel-confirm signal, which corresponds to a channel-confirm command generated by the first command generator 113 and associated with the identification information that corresponds to the first device 1, to the second device 5 so as to confirm receipt of the channel-designate signal.

In step 905, the second device 5 is configured to proceed to step 906 if the second device 5 receives the channel-confirm signal within a predetermined interval after transmitting the channel-designate signal to the first device 1, and to proceed to step 903 if otherwise.

In step 906, the second device 5 is configured to repeatedly transmit a channel-established signal, which corresponds to a channel-established command generated by the second command generator 513 and associated with the identification information that corresponds to the first device 1, to the first device 1 so as to maintain a live connection between the first and second devices 1, 5.

In the present invention, not only is the first device 1 able to switch the second device 5 between operational and standby states, communication channel designation is also conducted during switching to the operational state. Therefore, remote control of the wireless digital audio reproduction system 100 is facilitated, establishment of a channel connection is simpler and quicker, and reliability of remote control is enhanced without using a complicated framework, such as the OSI reference model.

The wireless digital audio reproduction system 100 of the first preferred embodiment may be configured to perform steps of a modification of the method of the first preferred embodiment.

In step 301, the second device 5 is configured to power on the portion of the components thereof during a current one of the intermittent power-on intervals.

In step 302, during the current one of the intermittent power-on intervals, the channel selector 512 of the second device 5 is configured to determine whether an interference-and-noise level of the current one of the communication channels is below a predetermined threshold, to proceed to step 304 if affirmative, and to proceed to step 303 if otherwise.

In step 303, the second device 5 is configured to power off the portion of the components thereof during a current one of the intermittent power-off intervals, and to proceed back to step 301 for subsequently determining the interference-and-noise level of a next one of the communication channels during a next of one of the intermittent power-on-intervals.

In step 304, the second device 5 is configured to transmit a channel-designate signal, which corresponds to a channel-designate command generated by the second command generator 513 and associated with information corresponding to the current one of the communication channels, to the first device 1, and to proceed to step 305. Upon receipt of the channel-designate signal, the first device 1 is configured to generate and transmit a channel-confirm signal, which corresponds to a channel-confirm command generated by the first command generator 113 and associated with the identification information that corresponds to the first device 1, to the second device 5 so as to confirm receipt of the channel-designate signal.

In step 305, the second device 5 is configured to proceed to step 306 if the second device 5 receives the channel-confirm signal within a predetermined interval after the second device 5 transmitted the channel-designate signal to the first device 1, and to proceed to step 303 if otherwise.

In step 306, the second device 5 is configured to repeatedly transmit a channel-established signal, which corresponds to a channel-established command generated by the second command generator 513 and associated with the identification information that corresponds to the first device 1, to the first device 1 via the designated communication channel so as to maintain alive connection between the first and second devices 1, 5.

After performing step 306, the first device 1 may begin transmitting of audio signals acquired by the microphone pick-up-head 14 thereof via the designated communication channel to the second device 5 for audible reproduction by the audio reproduction module 55.

It is to be noted that, in the modification, the first device 1 need not actively transmit the operational signal to the second device 5 upon triggering of the operation switch 15 so as to switch the second device 5 from the standby state to the operational state. Instead, the first device 1 is configured to switch the second device 5 to the operational state by merely transmitting the channel-confirm signal to the second device 5 via the communication channel through which the first device 1 receives the channel-designate signal from the second device 5. The steps of the modification of the method are relatively simple and introduce less interference to an environment in which a plurality of the wireless digital audio reproduction systems 100 are deployed.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A wireless digital audio reproduction system comprising:
a first device including
a first wireless communication module, and
a first control module coupled to said first wireless communication module, and configured to control said first wireless communication module, in response to triggering when said first device is in a standby state, for generating an operational signal associated with identification information that corresponds to said first device, and for transmitting the operational signal thus generated via at least one of a plurality of communication channels; and
a second device including
a second wireless communication module, and
a second control module coupled to said second wireless communication module, and configured to control said second wireless communication module for receiving the operational signal via a designated one of the communication channels, and to determine whether to control said second device to enter an operational state according to the operational signal received thereby, the designated one of the communication channels being designated by one of said first and second control modules;
wherein, when said second wireless communication module receives the operational signal, said second control module is configured to control said second wireless communication module for generating a channel-designate signal associated with the identification information that corresponds to said first device, and for transmitting the channel-designate signal thus generated to said first device;
whereby said first device transmits information to said second device through the designated one of the communication channels when said first device receives the channel-designate signal.

2. The wireless digital audio reproduction system as claimed in claim 1, wherein the designated one of the communication channels is designated by said second control module.

3. The wireless digital audio reproduction system as claimed in claim 2, wherein:
said first control module is configured to control said first wireless communication module to transmit the operational signal to said second device via a group of the communication channels during each first predetermined duration; and
said second control module includes a channel selector configured to determine an interference-and-noise level of a current one of the communication channels during a current one of intermittent power-on intervals, and to designate the current one of the communication channels as the designated one of the communication channels if the interference-and-noise level of the current one of the communication channels is below a predetermined threshold level and said second wireless communication module receives the operational signal via the current one of the communication channels.

4. The wireless digital audio reproduction system as claimed in claim 3, wherein, if said second wireless communication module fails to receive the operational signal via the current one of the communication channels during the current one of the intermittent power-on intervals, said channel selector is further configured to determine the interference-and-noise level of a next one of the communication channels during a next one of the intermittent power-on intervals, to attempt to receive the operational signal via the next one of the communication channels during the next one of the intermittent power-on intervals if the interference-and-noise level of the next one of the communication channels is below the predetermined threshold level, and to designate the next one of the communication channels as the designated one of the communication channels if the interference-and-noise level of the next one of the communication channels is below the predetermined threshold level and said second wireless communication module receives the operational signal via the next one of the communication channels.

5. The wireless digital audio reproduction system as claimed in claim 3, wherein the first predetermined duration is not shorter than the intermittent power-on interval, and, during each intermittent power-on interval, said first control module is configured to control said first wireless communication module to transmit the operational signal via at least two of the group of the communication channels.

6. The wireless digital audio reproduction system as claimed in claim 1, wherein:
said first control module is further configured to control said first wireless communication module for receiving the channel-designate signal, for generating a channel-confirm signal associated with the identification information that corresponds to said first device upon receipt of the channel-designate signal, and for transmitting the channel-confirm signal thus generated to said second device via the designated one of the communication channels; and
said second control module is further configured to control said second wireless communication module for receiving the channel-confirm signal via the designated one of the communication channels, and enables said second device to enter the operational state upon receipt of the channel-confirm signal.

7. The wireless digital audio reproduction system as claimed in claim 6, wherein said second control module is configured to control said second wireless communication module to generate the channel-designate signal and to transmit the channel-designate signal to said first device again if said second device fails to receive the channel-confirm signal within a second predetermined duration after transmitting the channel-designate signal to said first device, the second predetermined duration being shorter than the intermittent power-on interval.

8. The wireless digital audio reproduction system as claimed in claim 1, wherein:
said first control module is further configured to control said first wireless communication module, in response to triggering when said first device is in the operational state, for generating a standby signal associated with the identification information that corresponds to said first device, and for transmitting the operational signal thus generated to said second device via the designated one of the communication channels;
said second control module is further configured to control said second wireless communication module for receiving the standby signal via the designated one of the communication channels, and to determine whether to control said second device to enter a standby state according to the standby signal received thereby;
wherein, when said second wireless communication module receives the standby signal, said second control module is further configured to control said second wireless communication module for generating a standby-receipt signal associated with the identification information that corresponds to said first device, and for transmitting the standby-receipt signal thus generated to said first device;
whereby said first and second devices enter the standby state after said first device receives the standby-receipt signal.

9. The wireless digital audio reproduction system as claimed in claim 8, wherein power consumption of said second device in the standby state is lower compared to that in the operational state.

10. The wireless digital audio reproduction system as claimed in claim 1, wherein:
said first control module includes
a first encoder operable to perform a first encoding process upon first control commands received thereby so as to generate corresponding first encoded signals, and
a first decoder operable to perform a first decoding process upon second demodulated signals received thereby so as to generate corresponding second decoded commands;
said first wireless communication module includes
a first signal transmitter coupled to said first encoder for receiving the first encoded signals therefrom, and operable to perform a first modulation process upon the first encoded signals so as to generate corresponding first modulated signals, and to transmit the first modulated signals to said second device via the designated one of the communication channels, and
a first signal receiver operable to perform a first demodulation process upon second modulated signals received thereby so as to generate the second demodulated signals, and coupled to said first decoder for providing the second demodulated signals thereto;
said second wireless communication module includes
a second signal receiver for receiving the first modulated signals from said first signal transmitter via the designated one of the communication channels, and operable to perform a second demodulation process upon the first modulated signals so as to generate corresponding first demodulated signals, and
a second signal transmitter operable to perform a second modulation process upon second encoded signals received thereby so as to generate the second modulated signals, and to transmit the second modulated signals to said first device; and
said second control module includes
a second decoder coupled to said second signal receiver for receiving the first demodulated signals therefrom, and operable to perform a second decoding process upon the first demodulated signals so as to generate corresponding first decoded commands, and
a second encoder operable to perform a second encoding process upon second control commands received thereby so as to generate the second encoded signals, and coupled to said second signal transmitter to provide the second encoded signals thereto.

11. The wireless digital audio reproduction system as claimed in claim 1, wherein the designated one of the communication channels is designated by said first control module.

12. The wireless digital audio reproduction system as claimed in claim 11, wherein said first control module includes
a channel selector configured to determine an interference-and-noise level of a current one of the communication channels during a current one of predetermined intervals, and to designate the current one of the communication channels as the designated one of the communication channels if the interference-and-noise level of the current one of the communication channels is below a predetermined threshold level.

13. The wireless digital audio reproduction system as claimed in claim 12, wherein said channel selector is configured to determine the interference-and-noise level of a next one of the communication channels during a next one of the predetermined intervals if said first device fails to receive the channel-designate signal from said second device within a predetermined duration after transmitting the operational signal to said second device via the designated one of the communication channels, and to designate the next one of the communication channels as the designated one of the communication channels if the interference-and-noise level of the next one of the communication channels is below the predetermined threshold level.

14. The wireless digital audio reproduction system as claimed in claim 1, wherein said first device is a wireless audio source, and said second device is a wireless audio receiver device.

15. The wireless digital audio reproduction system as claimed in claim 1, wherein said second device sends information to said first device via the designated one of the communication channels.
